(19) United States
(12) Patent Application Publication
(10) Pub. No.: US 2002/0129938 A1
(43) Pub. Date: Sep. 19, 2002

(54) Energy-exchange pressure-elevating liquid transfer system

(76) Inventors: Darryl West, Calgary (CA); Ashraf Rajabali, Calgary (CA)

Correspondence Address: Sean W. Goodwin, Goodwin Berlin McKay, The Burns Building, Suite 360, 237-8th Avenue S.E., Calgary, AB, T2G 5C3, CA

(21) Appl. No.: 10/098,422

(22) Filed: Mar. 18, 2002

Related U.S. Application Data
(60) Provisional application No. 60/276,507, filed on Mar. 19, 2001.

(51) Int. Cl. E21B 43/34; F17D 1/14

(52) U.S. Cl. 166/267; 166/369; 166/75.12; 166/91.1; 137/13

(57) ABSTRACT

A system takes low pressure (LP) liquid and transfers them into a high pressure (HP) gas pipeline using an energy transfer system. A volume of HP gas is used as the energy source for driving a lesser volume of LP liquid into a HP downstream system. Preferably, liquids separated from wellhead effluent are separated from gases and are directed to the energy transfer pump for transfer into a HP gas pipeline. Substantially dry gases from the HP pipeline are directed to the energy transfer pump for providing the drive energy for elevating the pressure of the liquids. This system eliminates the prior art blowcase vessel system and does not require onsite utilities.

### CROSS REFERENCE TO RELATED APPLICATION

This application is a regular application from U.S. Provisional application No. 60/276,507, filed Mar. 19, 2001 is hereby incorporated in its entirety by reference.

### FIELD OF THE INVENTION

The invention relates to method and apparatus for transferring low pressure liquid, separated from well effluent, into a high pressure pipeline or gas transmission line. More particularly, an energy transfer pump is used to apply HP drive gas to power a pump to lift lower pressure liquid to the line pressure.

### BACKGROUND OF THE INVENTION

Produced natural gas and natural gas pipelines normally contain a mixture of gas and liquids. For transmission purposes, the gas is compressed using a gas compressor to a high pressure and transported in a gas transmission line or pipeline. Compressors are typical pressure increasing devices. Because free liquids can damage gas compressors, the liquids can not accompany the gas into the gas compressor. To enable increase in pressure of both liquids and gases, the gas component is first separated from the liquid components in a separator before compression. Typically the effluent from a gas well is at a low pressure which is greater than atmospheric. The liquid remains at low pressure and accumulates. Sometimes it is desirable or necessary to transfer the liquid to the high pressure gas pipeline. Accordingly, the pressure of the liquid must be increased to a higher pressure to match the higher pressure pipeline conditions.

As shown in FIG. 1, the most common prior art solution to handle the liquid component is a blowcase system which utilizes a separate blowcase vessel, cycled between low and high pressure. The overall blowcase system is controlled by a series of automatic valves that collect, store and unload separated liquids from the vessel in a particular sequence. Low pressure gas and liquid is separated in the low pressure separator and the substantially dry gases are directed to the compressor. Compressed gas is introduced to a high pressure pipeline. Initially, low pressure liquids from the separator are directed into the blowcase vessel which is also initially at a low pressure. Periodically, and during part of the cycle, the blowcase vessel is isolated from the separator and, gas from the gas compressor or high pressure pipeline is introduced to the vessel to pressurize the blowcase vessel. The collected liquids are then forced out of the blowcase vessel, under a slight differential pressure formed in the high pressure pipeline, and are transferred to join the higher pressure gases in the pipeline.

The aforementioned slight differential pressure is required when using gas at given pressure to be able to provide the head required to drive the gas and liquids back into the substantially same pressured source. Normally a pressure drop is formed in the high pressure gas line using a control device of some sort so as to form a differential pressure having a slightly lower pressure downstream than the pressure upstream. Typically, a differential pressure valve is employed upstream of the liquid transfer point to facilitate this control; forming the differential pressure and sometimes to provide back pressure control for the gas compressor.

After the liquids are transferred, the blowcase vessel is returned to its initial low pressure state so as to enable collection of another batch, or cycle, of liquids from the separator. A connection communicating with the separator facilitates this de-pressurization. The blowcase system is a complicated and expensive solution, requiring costly flow and timing controls and related servicing, and a separate vessel designed for cyclic service which further exacerbates costs.

It is possible and known to use an electric-powered liquid pump to pressurize and re-inject the liquid into the pipeline. While being simple and less expensive than a blowcase system, it is often not possible to implement due to a lack of utilities and insufficient power available at remote facilities.

Similarly, it is also theoretically possible to use a common gas-driven (pneumatic) pump. However, this has also been an undesirable solution because this type of pump can not readily handle high pressure drive gas. Further, such pumps exhaust the drive gas at a pressure that is too low (less than wellhead pressure) to recover with the compressor, and therefore are typically vented to atmosphere. Also, the relatively high liquid flow rate demands a discharge of an unacceptably high volume of wasted and potentially noxious gas.

### SUMMARY OF THE INVENTION

The present apparatus and method of use utilizes substantially dry gas at high pressure for transferring low pressure liquids into high pressure systems. Such a situation includes the transfer of oil, condensate or water from well effluent and related site fluids associated with natural gas wells. An energy-transfer pump is employed in a manner which is distinguished from prior art implementations, more particularly being used for pumping liquids in only one direction (low pressure to high pressure) and accordingly, the pump drive circuit and the pumping circuit can be entirely independent. The implementation is typically employed to conduct liquids around a gas compressor, and not merely for circulation as is the case for regenerating chemical reactions. Further application of a dedicated level controller more finely regulates the flow of produced liquids. It is notable that other implementations of energy-exchange type pumps do not use a dedicated level controller to regulate liquid transfer rate as they use the gas/liquid mixture ratio on the pump's power side to achieve self-regulation.

Accordingly, in one preferred embodiment, liquids separated from a low pressure (LP) wellhead separator are transferred into high pressure (HP) compressed and substantially dry gases using an energy transfer system. A volume of HP gas is used as the energy source for driving a lesser volume of LP liquid into a HP downstream system. This system eliminates the blowcase vessel system and does not require onsite utilities.

More broadly, a system for accepting a stream of LP liquid recovered from wellhead effluent and transferring the liquid into a HP gas pipeline comprises: an energy transfer pump for conducting a stream of HP drive gas from the pipeline and through the pump's power side for extracting energy and thereby discharging a spent drive gas stream to a LP zone, and for conducting the LP liquid through the pump's pumping side for applying the extracted energy and thereby discharging a HP liquid for transfer to the pipeline. Preferably the system further comprises a level controller which adjusts the flow of HP drive gas through the pump's power side for controlling the discharge of HP liquid to the pipeline. A slipstream circuit preferably conducts liquid into the HP drive gas to aid in lubricating the pump.

The system enables a novel method for transferring LP liquid, separated from wellhead effluent, into a pipeline containing HP gas comprising the steps of: powering an energy transfer pump by supplying a power side of the energy transfer pump with a stream of HP drive gas from the pipeline to extract energy therefrom; supplying the separated liquids to a pumping side of the energy transfer pump for applying the extracted energy to produce a HP liquid stream; and discharging the HP liquid stream to the pipeline.

### BRIEF DESCRIPTION OF THE DRAWINGS

FIG. 1 is a schematic of the blowcase system of the prior art;

FIG. 2 is a schematic of a typical energy transfer system of the prior art; and

FIG. 3 is a schematic of a first embodiment of the system of the present invention;

FIG. 4 is a schematic of another embodiment of the invention according to FIG. 3 and which is controlling liquid discharge under level control;

FIG. 5 is a schematic of another embodiment of the invention according to FIG. 3 and which is further applying and controlling a differential pressure in the pipeline; and

FIG. 6 is a schematic of another embodiment of the invention according to FIG. 3 in which two alternate approaches to providing the energy transfer pump with a slipstream of liquid, level controls being omitted for clarity of the slipstream embodiment.

### DETAILED DESCRIPTION OF THE PREFERRED EMBODIMENT

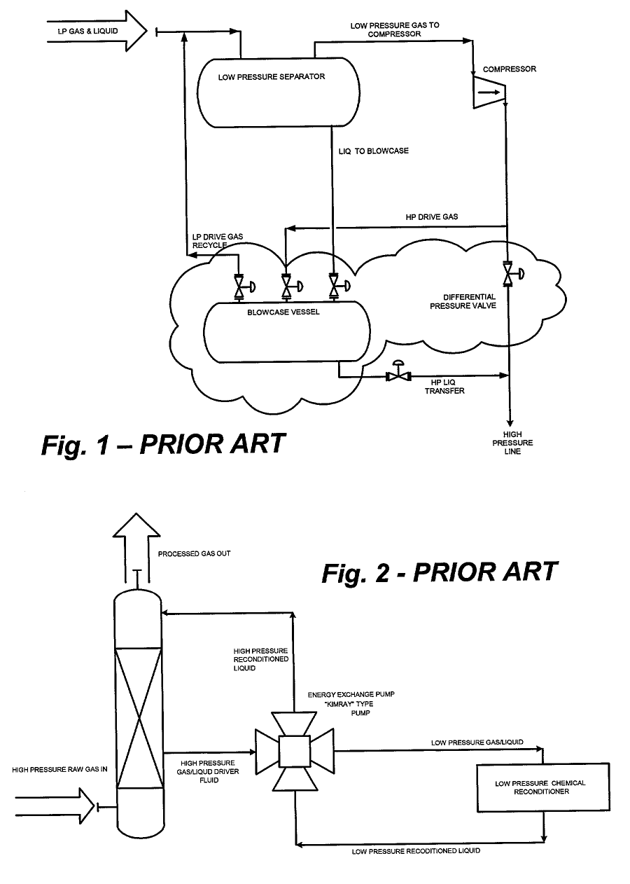

As shown in FIG. 1, the prior art utilizes a separate blowcase vessel for elevating the pressure of liquids for discharge into a high pressure pipeline. The apparatus and method of the present invention obviates the prior art need and reliance upon a blowcase vessel and can also eliminate the differential pressure valve. The surplus prior art equipment is illustrated in a graphic balloon in FIG. 1.

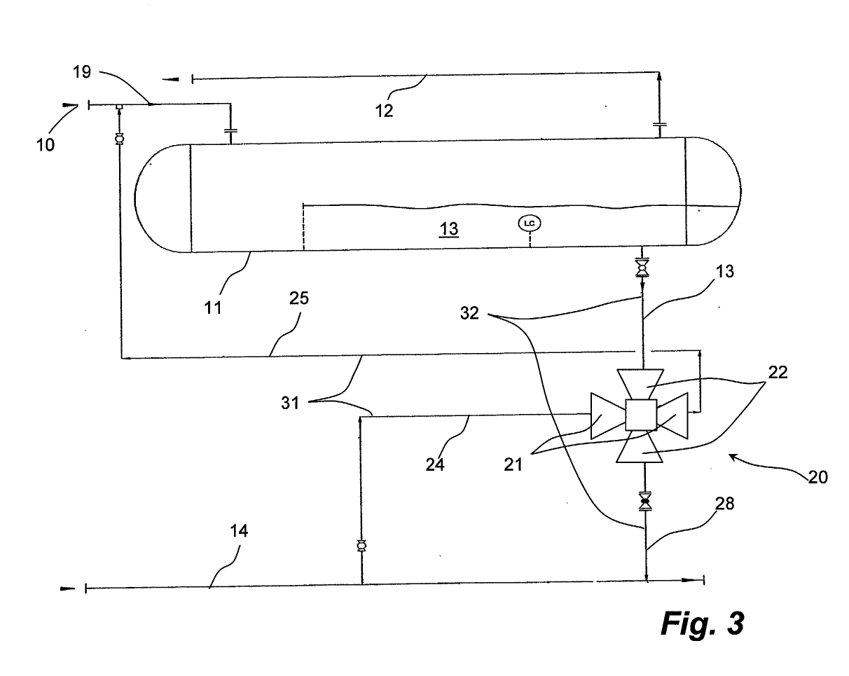

With reference to FIG. 1 and FIG. 3, operations such as an oil and hydrocarbon gas well, produce gas and liquid effluent 10 which is directed to a separator 11 for producing a substantially dry gas steam 12 and a liquid stream 13. The effluent 10 and separator 11 are at a low pressure (LP) which is typically above atmospheric but is less than that needed to enter a high pressure (HP) gas transmission line or pipeline 14 directly. Typically LP gas from the separator 12 is directed for further processing. Often this processing includes compression at a compressor 15 (FIG. 1) for compression and introduction to the HP gas pipeline 14. There is also an objective to accumulate the separated liquid 13 and inject it for transfer into the HP pipeline 14. Note that the gas pipeline is substantially gas but may contain some liquids.

With reference to FIG. 3 and in accordance with a first embodiment of the invention, the LP separator 11 is fitted with an energy transfer pump 20. The pump 20 utilizes an onsite source of HP fluid to fund energy required to transfer LP liquid 13 to a HP gas pipeline 14. Typically, the source of HP fluid is the gas drawn from the HP gas pipeline 14 itself. The invention is directed to raising the pressure of LP liquids (separated from well effluent or otherwise) and injecting them into a HP destination such as the HP pipeline 14. As a result, the HP gas pipeline 14 is a combination of primarily gas and some liquids and the source of HP gas is preferably drawn from a high point on the pipeline to avoid entrainment of liquids.

Energy transfer pumps 20 are commercially available such as those available from Kimray Inc. of Oklahoma City, Okla. and Rotor-Tech Inc. of Houston, Tex. The form and function of the Kimray pump is described in U.S. Pat. No. 2,990,910 to Kimmel in 1961, the entirety of which is incorporated by reference herein. This Kimray pump is still in use today. These energy transfer pumps 20 are typically implemented in systems designed to circulate glycol, amine or process chemicals in natural gas dehydrator or Amine Sweetening plants. These are closed loop applications with circulation in two directions. As shown in FIG. 2, these prior art systems utilize energy-exchange and pair of pumping chambers to pump invigorated process chemicals from low pressure to high pressure which is energy funded by a pair of power chambers utilizing higher energy discharge of exhausted chemicals from a high pressure and flowing to low pressure. In the Kimray pump, the area of the power chambers is greater than that of the pumping chambers so that the force or pressure-volume energy of the system can result in even higher pressure output from the pumping side. In such glycol supply systems, the high energy driver fluid is actually a multiphase solution of liquids mixed with gas and it is the composition of this solution (gas:liquid ratio) that controls the fluid transfer rate. The driven low energy fluid, on the other hand, is typically and substantially fully liquid phase. The energy-exchange balances itself and no other power is required.

By incorporating an energy transfer pump with a LP separator 11 and a HP gas pipeline 14, the traditional blowcase system can be completely eliminated and the system is powered without wastage of drive gas.

A typical pressure-volume or energy-exchange pump 20 implements principles of the energy-exchange pump as set forth in U.S. Pat. No. 2,990,910. As the pump 20 is operated within a system, energy is transferred by balancing volumes and pressures; a volume of HP fluid is consumed for transferring a lesser volume of LP fluid from another part of the system. As set forth for a Kimray pump in U.S. Pat. No. 2,990,910, the Kimray pump utilizes a piston-rod assembly having a large area piston and a lower area piston rod side. A pilot piston alternately feeds HP fluid to power cylinders at each end of the piston-rod assembly to enable pumping from the rod side.

More particularly, as shown in FIG. 3, a basic system is depicted in which high energy fluid is delivered to a power side 21 for driving the pump 20. Low energy fluid, in this case the separated LP liquid 13, is delivered to a pumping side 22. The power side 21 provides the energy for driving the pump 20.

A power circuit 31 connects the pump's power side 21 at an inlet to a supply stream of HP drive gas 24 communicating with a HP source, such as the HP gas pipeline 14 and a stream of spent drive gas 25 flows from an outlet and is connected to a LP zone or destination such as an inlet 19 of the LP separator 11. A pumping circuit 32 connects the pumping side 22 to a supply stream of LP liquid 13 such as that issuing from the LP separator 11. A stream of HP liquid 28 is discharged through the pumping circuit from the pumping side at an outlet and flows to HP gas pipeline 14.

The HP drive gas 24, after doing work in the pump, is discharged as spent drive gas 25 from an outlet of the power side 21 and flows to combine with a zone of low pressure such as with well effluent 10 at the separator 11 for further processing.

The steam of LP liquids 13, whether from the separator 11 or more generally from any other LP liquid source, have their energy raised by the pump 20 to a higher pressure and resulting HP liquids 28 are thereby transferred into the HP gas pipeline 14. Alternatively, after due consideration to environmental and cost-control issues, the spent drive gas 25 can be vented to atmosphere (not shown). The system as described requires only a pump 20 with few controls if any at all.

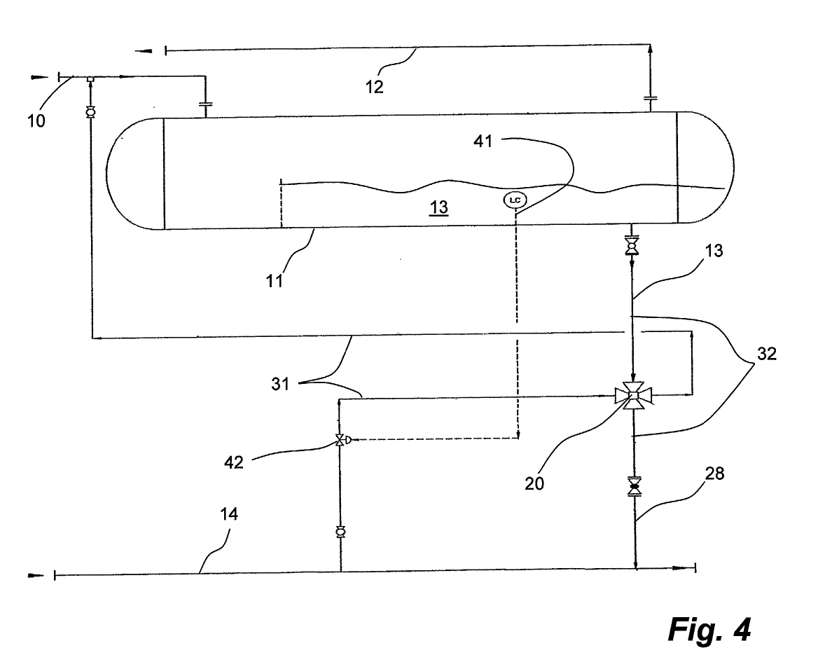

With reference to FIG. 4, LP liquid 13 can be transferred to the HP gas pipeline under level control for improved control. The separator 11 has a sump 40 for accumulating liquid 13 and a level controller 41. The level controller 41 controls a motor valve 42 on the pump's power side in the stream of HP drive gas 24. This alters the flow of HP drive gas and thereby activates, deactivates or throttles the pump 20 concomitant with the level of liquid 13 in the separator 11. The level controller 41 can be one of a variety of common instruments found on conventional separators 11.

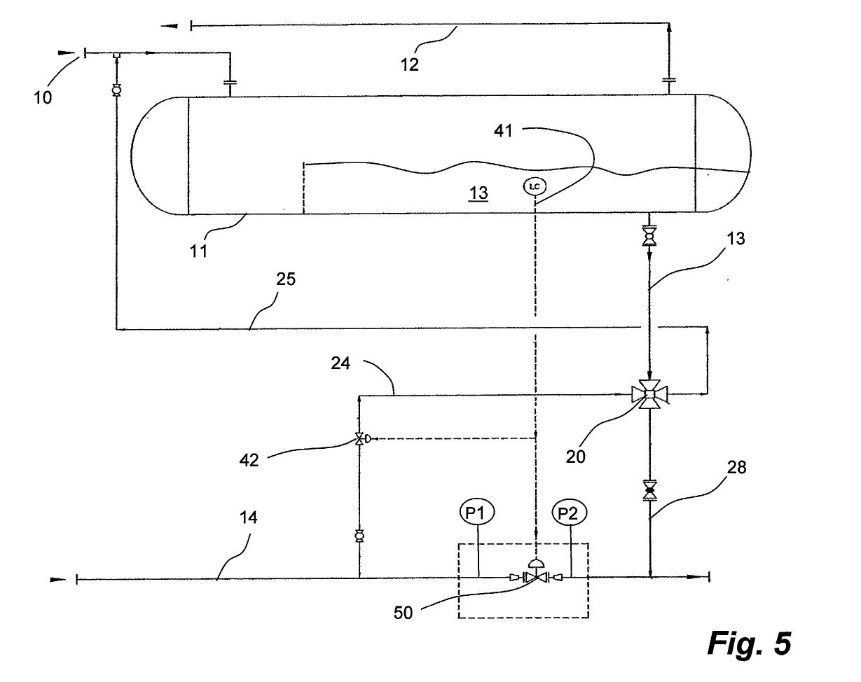

Turning to FIG. 5, control of the liquid transfer can be further aided by the installation of an optional differential pressure valve 50. The valve 50 can be used to provide backpressure on a compressor, regulating its performance. Further, the valve 50 interferes with the flow of HP gas in the pipeline and forms a HP stream upstream P1 and a slightly lower pressure P2 downstream. By taking advantage of the small pressure differential created P1−P2, less HP drive gas 24 is required to elevate the pressure of the LP liquid 13. Conveniently, the level controller can be set to deactivate the differential pressure valve 50 when there is not need to dump liquid and activate the operation of the valve 50 when performing liquid transfer.

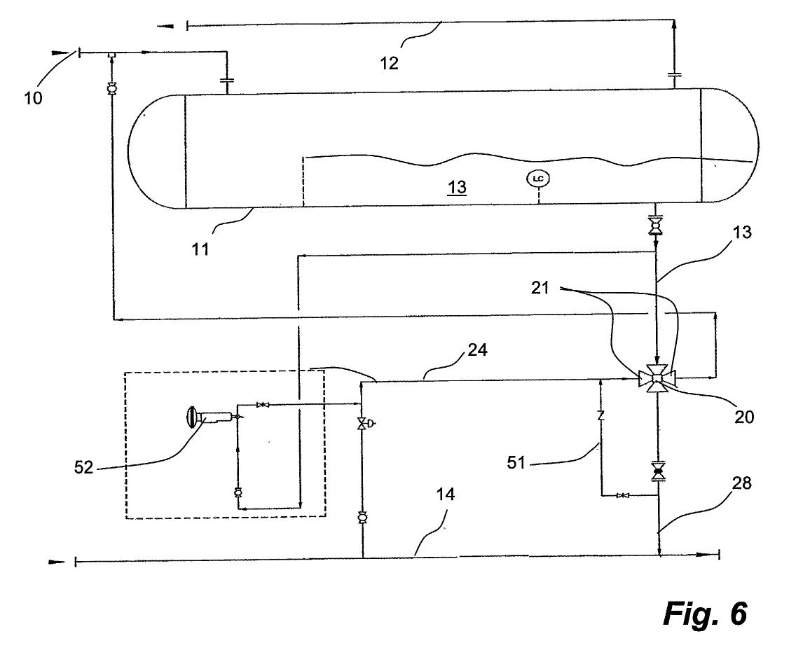

With reference now to FIG. 6, as the HP drive gas 24 is substantially dry, a lubrication circuit 51 is provided by directing a fraction of the pumped HP liquids 28 as a slipstream 51 into the HP drive gas 24 to keep the power side 21 of the pump 20 lubricated. Alternatively, an external pneumatic pump 52 may be employed in an alternate lubrication circuit 52 to provide lubrication, conveniently using the liquids from the streams of LP liquid 13 or HP liquid 28.

As set forth above the prior art energy-transfer pump has been applied in a new and advantageous manner.

Advantages of the present invention include an increase in safety as one avoid large volumes of HP drive gas, and the use of a vessel subject to cyclic loading and eventual fatigue. Economics are improved by eliminating use of a second vessel (blowcase vessel) and minimizing the use of a differential pressure valve, other valves and controls. The present invention is less expensive in capital, operating & maintenance cost by eliminating the prior art blowcase system.

The current system also has operational advantages over the prior art. No electricity required and, if the spent drive gas is routed to the separator, there are no emissions to atmosphere or wasted gas. The system is compact and is easily retrofit to the inside existing separator buildings on-site and is easier to operate including reduced complications with timing of the blowcase method of cyclic high-pressure state to low-pressure state, timing of the dump cycle and other similar issues. Overall the system is simple, with fewer controls and valves than the prior art blowcase system. Due to the simplicity of the system, a redundant standby system is possible for increased reliability.

Further, in certain situations, the present invention obviates the requirement for a pressure differential valve downstream of the gas compressors as is needed for a blowcase system. It is clear that the system can be applied to great effect and economy in replacing expensive equipment. Further, eliminating the need for blowcase vessel charging cycles results in a lesser compressor load.

The embodiments of the invention in which an exclusive property or privilege is claimed are defined as follows:

1. A system for accepting a stream of low pressure (LP) liquid recovered from wellhead effluent and transferring the liquid into a pipeline containing gas at a high pressure (HP) greater than that of the LP liquid comprising:
an energy transfer pump having a power side and a pumping side;
a power circuit for conducting a stream of HP drive gas from the pipeline and through the pump's power side for extracting energy therefrom and discharging a LP spent drive gas to a LP zone; and
a pumping circuit for conducting the LP liquid through the pump's pumping side for applying the extracted energy and discharging a HP liquid for transfer into the pipeline.

2. The system of claim 1 further comprising a separator for processing the wellhead effluent to first separate a gas stream from a liquid stream and wherein the separated liquid stream forms the LP liquid.

3. The system of claim 2 wherein the LP zone comprises the separator.

4. The system of claim 1 further comprising a flow controller positioned between the pipeline and the power side for controlling the flow of HP drive gas through the power circuit and thereby controlling the flow of LP liquid through the pumping circuit.

5. The system of claim 4 further comprising:
a LP separator at the wellhead for separating gas and LP liquid from the well effluent and accumulating LP liquid in the separator for forming a liquid level therein; and
a level controller adapted for adjusting the flow controller and thereby controlling the liquid level in the LP separator.

6. The system of claim 1 further comprising a slipstream connection between
an outlet from the pumping circuit between the pump's pumping side and the HP pipeline, and
an inlet to the power circuit between the pipeline and the pump's power side for directing a slipstream of HP liquid from the pumping circuit to the power circuit for lubricating the energy transfer pump.

7. The system of claim 1 further comprising:
a valve located in the HP pipeline for establishing a high pressure gas stream and a lower pressure downstream gas stream and a forming a differential pressure therebetween and wherein the HP drive gas for the power circuit is connected to the pipeline's upstream gas stream and the HP liquid is discharged to the pipeline's downstream gas stream.

8. The system of claim 5 further comprising a slipstream connection between
an outlet from the pumping circuit between the pump's pumping side and the pipeline, and
an inlet to the power circuit between the pipeline and the pump's power side for directing a slipstream of HP liquid from the pumping circuit to the power circuit for lubricating the energy transfer pump.

9. The system of claim 5 further comprising:
a controller located in the HP pipeline for establishing a high pressure gas stream and a lower pressure downstream gas stream and a forming a differential pressure therebetween and wherein the HP drive gas for the power circuit is connected to the pipeline's upstream gas stream and the HP liquid is discharged to the pipeline's downstream gas stream.

10. A method of transferring low pressure (LP) liquid, separated from wellhead effluent, into a pipeline containing high pressure (HP) gas comprising the steps of:
powering an energy transfer pump by supplying a power side of the energy transfer pump with a stream of HP gas from the pipeline and extracting energy therefrom;
supplying the separated liquids to a pumping side of the energy transfer pump for applying the extracted energy to produce a HP liquid stream;
discharging the HP liquid stream to the pipeline.

11. The method of claim 10 further comprising the step of discharging a stream of spent drive gas from the pump's power side back to the wellhead effluent.

12. The method of claim 10 further comprising processing the wellhead effluent in a separator to produce a LP gas stream and the LP liquid stream.

13. The method of claim 12 further comprising discharging the spent drive gas to the separator.

14. The method of claim 10 further comprising controlling the flow of gas through the power circuit and thereby controlling the flow of liquid through the pumping circuit.

15. The method of claim 10 further comprising:
separating gas and liquids from the well effluent in a separator;
accumulating liquid in the separator for forming a liquid level; and
controlling the liquid level in the separator by controlling the flow of gas through the power circuit.

16. The method of claim 10 further comprising directing a slipstream of HP liquid into the power circuit between the pipeline and the pump's power side for lubricating the energy transfer pump.

17. The method of claim 10 further comprising establishing a differential pressure in the pipeline for
forming a high pressure upstream gas stream for supplying the pump's power side,
forming a lower pressure downstream gas stream, and
discharging the HP liquid to the downstream gas stream.

18. The method of claim 15 further comprising directing a slipstream of HP liquid into the power circuit between the pipeline and the pump's power side for lubricating the energy transfer pump.

19. The method of claim 15 further comprising establishing a differential pressure in the pipeline for:
forming a high pressure upstream gas stream for supplying the pump's power side,
forming a lower pressure downstream gas stream, and
discharging the HP liquid to the downstream gas stream.
